(19) United States
(12) Patent Application Publication
(10) Pub. No.: US 2017/0154057 A1
(43) Pub. Date: Jun. 1, 2017

(54) EFFICIENT CONSOLIDATION OF HIGH-VOLUME METRICS

(71) Applicant: LinkedIn Corporation, Mountain View, CA (US)

(72) Inventors: Bin Wu, Palo Alto, CA (US); Weiqin Ma, San Jose, CA (US); Qiang Zhu, Sunnyvale, CA (US); Yuankui Sun, Mountain View, CA (US); Yan Liu, Sunnyvale, CA (US); Weidong Zhang, San Jose, CA (US); Hong Lu, Fremont, CA (US)

(73) Assignee: LinkedIn Corporation, Mountain View, CA (US)

(21) Appl. No.: 14/954,303

(22) Filed: Nov. 30, 2015

(51) Int. Cl. G06F 17/30

(52) U.S. Cl. CPC G06F 17/30303; G06F 17/30321; G06F 17/30386

(57) ABSTRACT

The disclosed embodiments provide a system for processing data. During operation, the system obtains a set of records from a set of inputs, with each record containing an entity key, a partition key, and one or more attribute-value pairs. For each attribute-value pair in the records, the system maps an attribute name in the attribute-value pair to a unique identifier for the attribute name and replaces the attribute name with the unique identifier. The system then identifies a subset of the records with a matching entity key and a matching partition key and merges the subset of the records into a single record that includes the matching entity key, the matching partition key, and a single field containing a list of attribute-value pairs from the subset of the records. Finally, the system provides the single record and the mapping for use in querying from a centralized source.

### BACKGROUND

Field

The disclosed embodiments relate to data analysis. More specifically, the disclosed embodiments relate to techniques for efficiently processing high-volume metrics for data analysis.

Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools, relational databases, and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, big data analytics may be associated with a tradeoff between performance and memory consumption, in which compressed data takes up less storage space but is associated with greater latency, and uncompressed data occupies more memory but can be analyzed and/or queried more quickly.

Consequently, big data analytics may be facilitated by mechanisms for efficiently collecting, storing, managing, compressing, transferring, sharing, analyzing, and/or visualizing large data sets.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

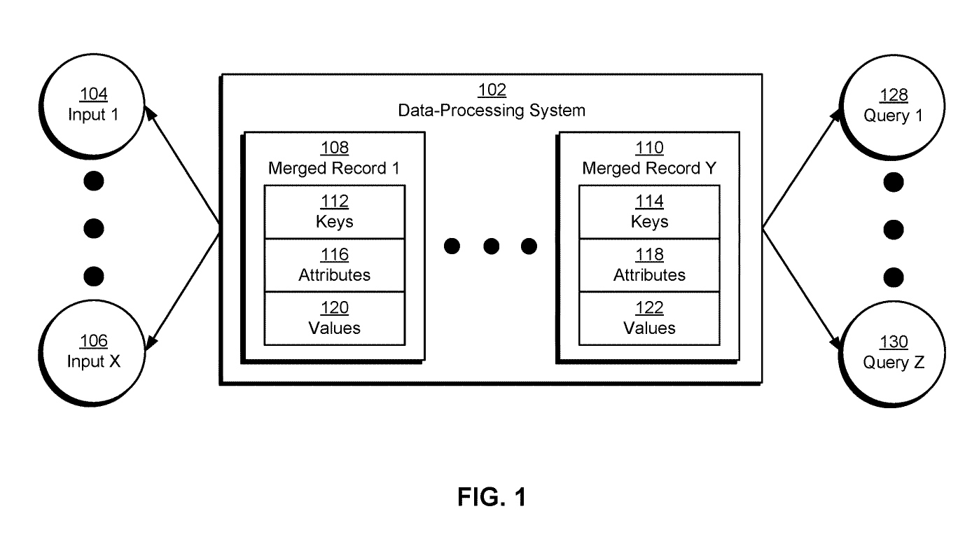

The disclosed embodiments provide a method and system for processing data. As shown in FIG. 1, the system may be a data-processing system 102 that collects data from a set of inputs (e.g., input 1 104, input×106) and generates a set of merged records (e.g., merged record 1 108, merged record y 110) from the data. For example, data-analysis system 102 may generate merged records from events, purchases, sensor data, user activity, anomalies, faults, failures, and/or other data points provided by the inputs, which may provide their data from various locations.

More specifically, data-processing system 102 may consolidate data from multiple inputs into the merged records. The inputs may represent different sources of metrics, dimensions, and/or other parameters that are generated, calculated, measured, and/or otherwise obtained by different groups, statistical models, monitoring mechanisms, and/or analytics systems. Data-processing system 102 may collect the parameters from the inputs and merge the parameters into the records, thus providing a centralized location for storing and accessing the parameters.

Data-processing system 102 may then provide the merged records for use with queries (e.g., query 1 128, query z 130) associated with the data. For example, data-processing system 102 may enable analytics queries that are used to discover relationships, patterns, and/or trends in the data; gain insights from the data; and/or guide decisions and/or actions related to attributes 116-118 and/or values 120-122. In other words, data-processing system 102 may include functionality to support the efficient collection, storage, processing, and/or querying of big data.

As shown in FIG. 1, merged records generated by data-processing system 102 may include keys 112-114, attributes 116-118, and values 120-122. Attributes 116-118 and values 120-122 may define the parameters (e.g., metrics, dimensions, etc.) that have been measured, calculated, and/or collected by the teams, models, and/or systems represented by the inputs. For example, attributes 116-118 and values 120-122 may be specified in attribute-value pairs, in which the attribute of each attribute-value pair represents the name of a given parameter and the value in the attribute-value pair represents the value of the parameter.

In one or more embodiments, metrics and dimensions represented by attributes 116-118 and values 120-122 are associated with user activity at an online professional network. The online professional network may allow users to establish and maintain professional connections, list work and community experience, endorse and/or recommend one another, search and apply for jobs, and/or engage in other activity. Employers may list jobs, search for potential candidates, and/or provide business-related updates to users. As a result, the metrics may track values such as dollar amounts spent, impressions of ads or job postings, clicks on ads or job postings, profile views, messages, job or ad conversions within the online professional network, and/or other user behaviors, preferences, or propensities. In turn, the dimensions may describe attributes of the users and/or events from which the metrics are obtained. For example, the dimensions may include the users' industries, titles, seniority levels, employers, skills, and/or locations. The dimensions may also include identifiers for the ads, jobs, profiles, pages, and/or employers associated with content viewed and/or transmitted in the events. The metrics and dimensions may thus facilitate understanding and use of the online professional network by advertisers, employers, and/or other members of the online professional network.

Keys 112-114 may be used by data-processing system 102 to group parameters from multiple inputs into the merged records. Each row of data from an input may include one or more required keys, such as an entity key that represents an entity (e.g., member or company) in the online professional network and a partition key that represents a given partition (e.g., time interval, location, demographic, etc.) associated with the data. In turn, rows from disparate inputs with the same entity key and partition key may be aggregated into a single merged record by data-processing system 102.

In one or more embodiments, data-processing system 102 includes functionality to consolidate and store data from the inputs in an efficient and scalable manner. As described in further detail below, the data-processing system may enable compact storage of attributes 116-118 in the records by replacing the attributes with unique identifiers and creating a separate mapping of the attributes to the unique identifiers. The unique identifiers may thus serve as indexes to the corresponding attributes in the mapping. Data-processing system 102 may further store attributes 116-118 and values 120-122 in each merged record as a single field containing a list of attribute-value pairs, with null or other non-meaningful values omitted from the list. Finally, the data-processing system may use the mapping of attributes 116-118 to unique identifiers and a flexible configuration of data inputs to dynamically update the schemas associated with the inputs and the merged records. Consequently, data-processing system 102 may support efficient and flexible collection, processing, and storage of data for big data analytics.

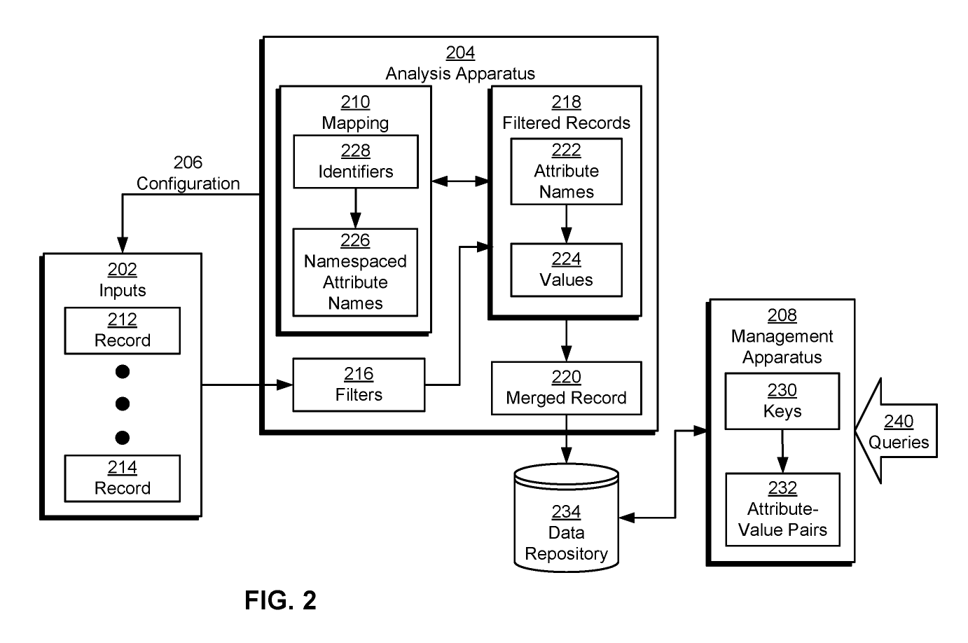

FIG. 2 shows a system for processing data (e.g., data-processing system 102 of FIG. 1) in accordance with the disclosed embodiments. The system of FIG. 2 includes an analysis apparatus 204 and a management apparatus 208. Each of these components is described in further detail below.

Analysis apparatus 204 may obtain a set of records 212-214 from a set of inputs 202. For example, analysis apparatus 204 may retrieve records 212-214 from multiple locations in a distributed filesystem, cluster, and/or other network-based storage. To load records 212-214 from inputs 202, analysis apparatus 204 may obtain a configuration 206 containing the names and/or locations of the inputs. For example, the analysis apparatus may obtain a configuration file that specifies a name and a path for each input source of data records 212-214 to be consolidated into a merged record 220. Because inputs 202 to analysis apparatus 204 are dynamically added, removed, or updated by changing a single configuration 206, changes to the set of inputs 202 may be easier to apply than data-processing mechanisms that use hard-coded or static scripts to retrieve data from input sources.

In one or more embodiments, each record 212-214 includes an entity key, a partition key, and one or more attribute-value pairs. The entity key may represent an entity associated with the record, such as a user, company, business unit, product, advertising campaign, and/or experiment. The partition key may represent a time interval (e.g., hour, day, etc.), location, demographic, and/or other logical or physical partition for the record.

The attribute-value pairs in the record may represent metrics, dimensions, and/or other parameters associated with the entity and partition. More specifically, the attribute-value pairs may be identified by attribute names 222 and the corresponding values 224 associated with the attribute names. For example, attribute-value pairs in a record of weekly user interaction with an online professional network may include attribute names such as “page_view_weekly,” “search_weekly,” and “invitation_weekly,” and values of these attributes may represent weekly page views, searches, and/or connection invitations, respectively, for a user represented by the entity key in the record. In other words, the attribute-value pairs of a record may be atomic data points that can be measured, discerned, and/or otherwise determined for a given entity and partition associated with the record.

In addition, each input may be associated with one or more schemas that describe the structure of data from the input. For example, an input named “abook_snapshot” may include the following schema:

{

```
“type” : “record”,
“fields” : [ {
  “name” : “member_sk”,
  “type” : [ “null”, “long” ]
}, {
  “name” : “date_sk”,
  “type” : [ “null”, “string” ]
}, {
  “name” : “imported_contacts”,
  “type” : [ “null”, “long” ]
}, {
  “name” : “imported_contacts_107d”,
  “type” : [ “null”, “long” ]
}, {
  “name” : “imported_contacts_130d”,
  “type” : [ “null”, “long” ]
}, (
  “name” : “is_uploaded_abook_107d”,
  “type” : [ “null”, “long” ]
}, {
  “name” : “is_uploaded_abook_130d”,
  “type” : [ “null”, “long” ]
}, {
  “name” : “is_uploaded_abook_190d”,
  “type” : [ “null”, “long” ]
} ]
```

}

The exemplary schema above may specify that records from the “abook_snapshot” input include an entity key named “member_sk” and a partition key named “date_sk.” The schema may also include a list of attribute-value pairs with attribute names of “imported_contacts,” “imported_contacts_107d,” “imported_contacts_130d,” “is_uploaded_abook 107d,” “is_uploaded_abook_130d,” and “is_uploaded_abook_190d” and values that are of type “null” or “long.”

Next, analysis apparatus 204 may apply one or more filters 216 to records 212-214 to generate a set of filtered records 218. First, the analysis apparatus may group records 212-214 by entity key and partition key. For example, the analysis apparatus may group records 212-214 from inputs 202 into distinct subsets, with records in each subset containing a matching entity key and a matching partition key. Each grouped subset of records may thus represent all the parameters collected for a given entity and partition across all available inputs 202 to the data-processing system.

Second, analysis apparatus 204 may use filters 216 to omit attribute-value pairs with non-meaningful values from filtered records 218. For example, filters 216 may be used to exclude attribute-value pairs with null values, zero numeric values for numeric data types, and/or other types of “default” values from the filtered records. As a result, filters 216 may facilitate efficient storage of sparse data from inputs 202, whereas a relational database and/or other table-based storage mechanism may require all null and/or non-meaningful values in the fields to be stored.

After filtered records 218 are generated, analysis apparatus 204 may combine the filtered records with a matching entity key and matching partition key into a single merged record 220 containing the entity and partition keys 230 and all attribute-value pairs 232 associated with the keys. For example, analysis apparatus 204 may generate merged record 220 in a flattened format such as AVRO. Keys 230 may be specified at the top of merged record 220, followed by a single field containing a list of attribute-value pairs 232 from all filtered records 218 that match the keys.

Analysis apparatus 204 may also modify attribute-value pairs 228 in filtered records 218 and/or merged record 220 in a way that facilitates efficient identification and storage of the attribute-value pairs. First, the analysis apparatus may generate unique, namespaced attribute names 226 for attributes in filtered records 218 and/or merged record 220 by adding the input name of the input from which each attribute-value pair was received to the attribute name of the attribute. Such concatenation of input names with attributes names may be used to distinguish between attribute-value pairs with the same attribute names from different inputs. Continuing with the exemplary schema above, analysis apparatus 204 may append the input name of “abook_snapshot” to the attribute name of “imported_contacts” to produce a namespaced attribute name of “abook_snapshot,imported_contacts” for all attribute-value pairs with the attribute name from the input. The namespaced attribute name may uniquely identify the attribute-value pairs from the input, even when other inputs have records with attribute names of “imported_contacts.”

Next, analysis apparatus 204 may generate a mapping 210 of a set of unique identifiers 228 to namespaced attribute names 226 and replace the attribute names in filtered records 218 and/or merged record 220 with the corresponding identifiers 228 from mapping 210. With reference to the “abook snapshot” input above, the analysis apparatus may produce the following exemplary mapping 210 of identifiers 228 to namespaced attribute names 226:
1, abook_snapshot,imported_contacts, long, 0
2, abook_snapshot,imported_contacts_107d, long, 0
3, abook_snapshot,imported_contacts_130d, long, 0
4, abook_snapshot,is_uploaded_abook_107d, long, 0
5, abook_snapshot,is_uploaded_abook_130d, long, 0
6, abook_snapshot,is_uploaded_abook_190d, long, 0
   In the mapping above, a numeric (e.g., integer) identifier is followed by the namespace, attribute name, data type, and default value represented by the identifier. For example, the numeric identifier of “1” is mapped to the namespaced attribute name of “abook_snapshot,imported_contacts,” a data type of “long,” and a default value of “0.”

In turn, analysis apparatus 204 may replace all instances of the “imported_contacts” attribute name from the “abook snapshot” input in attribute-value pairs 228 of merged record 220 with the numeric identifier of “1,” thus reducing the amount of space required to store attribute-value pairs containing the attribute name and/or namespaced attribute name. For example, the analysis apparatus may produce the following exemplary merged record 220 using the exemplary mapping 210 above:

{

```
“member_sk” : {
  “long” : 18467
},
“date_sk” : {
  “string” : “2015-08-15”
},
“metrics” : {
  “array” : [ {
```

```
“metrics_id” : {
  “int” : 1
},
“metrics_value” : {
  “long” : “236”
}
```

```
  },
  ... ]
}
```

}

The exemplary merged record 220 may include an entity key (i.e., “member_sk”) of 18467 and a partition key (i.e., “date_sk”) of “2015 Aug. 15.” The entity and partition keys 230 are followed by one or more attribute-value pairs 232 (i.e., “metrics”) in an array, with the first element of the array containing an attribute-value pair with a numeric identifier of 1 representing the namespaced attribute name of “abook_snapshot,imported_contacts” and a corresponding value of 236.

Analysis apparatus 204 may further apply a number of filters 216 to exclude a portion of attribute-value pairs 232 for a given matching entity key and matching partition key from merged record 220. For example, the analysis apparatus may expedite generation of merged record 220 from records 212-214 by excluding data from one or more inputs 202 and/or specific attribute-value pairs in records 212-214 from merged record 220. Such exclusion of data from merged record 220 may be performed during generation of filtered records 218 and/or during merging of filtered records 218 into merged record 220. Because merged record 220 can be generated from a subset of records 212-214 and/or attribute-value pairs in the records more quickly than from all records associated with a given matching entity key and matching partition key, such expedited creation of merged record 220 may facilitate testing and/or other customized usage of data from inputs 202.

Analysis apparatus 204 may store merged record 220 and mapping 210 in a data repository 234 such as a distributed filesystem, network-attached storage (NAS), and/or other type of network-accessible storage, for subsequent retrieval and use. For example, analysis apparatus 204 may store mapping 210 in a text file and merged record 220 in a binary file.

Management apparatus 208 may then use merged record 220 and mapping 210 to process queries 240 of data from inputs 202. For example, the management apparatus may provide a graphical user interface (GUI), command-line interface (CLI), and/or other type of interface for extracting a subset of attribute-value pairs 232 that match queries 240 from merged record 220 and/or other merged records in data repository 234. Because queries 240 are used to retrieve data provided by multiple inputs 202 from compact merged records 220 in a centralized data repository 234, the system of FIG. 2 may reduce overhead and/or inconsistencies associated with storing the data in conventional table-based structures, performing computationally expensive queries such as relational database joins across disparate data sets, reprocessing of the same data sets, and/or merging data from static input sources.

Analysis apparatus 204, management apparatus 208, and/or another component of the system may also process attribute-value pairs 232 in merged record 220 and/or other merged records and include the output of such processing for use by queries 240. For example, the component may generate and/or display summary statistics and/or visualizations such as a count of distinct values, minimum, maximum, mean, median, variance, quantile, and/or histogram distribution of values in attribute-value pairs 232. The component may also identify trends, seasonal components, and/or other components of time-series data represented by attribute-value pairs 232.

Those skilled in the art will appreciate that the system of FIG. 2 may be implemented in a variety of ways. First, data repository 234, analysis apparatus 204, and management apparatus 208 may be provided by a single physical machine, multiple computer systems, one or more virtual machines, a grid, one or more databases, one or more filesystems, and/or a cloud computing system. Analysis apparatus 204 and management apparatus 208 may additionally be implemented together and/or separately by one or more hardware and/or software components and/or layers.

Second, merged record 220 may be generated from records 212-214 in a number of ways. As mentioned above, merged record 220 may include some or all attribute-value pairs 228 for a given combination of entity and partition keys 230 from inputs 202. The system of FIG. 2 may thus include functionality to produce multiple versions of merged record 220 from different subsets of records 212-214 and/or attribute-value pairs 232 for the same entity key and partition key.

Along the same lines, multiple versions of merged record 220 may be produced from multiple partitions (e.g., daily partitions, weekly partitions, etc.) of data from inputs 202. For example, a series of merged records may be generated on a daily basis from records 212-214 with the same daily partition key from inputs 202. Attribute-value pairs from merged records and/or records 212-214 that span a period of seven days may then be aggregated into a merged record with a weekly partition key.

Attribute-value pairs 232 may further be grouped and consolidated into merged record 220 and/or other merged records in data repository 234 according to different keys 230 or sets of keys. For example, all attribute-value pairs 232 associated with a given entity key may be listed under a single merged record (e.g., merged record 220) for the entity key. Within the merged record, each element in the list may be represented by an attribute name and/or identifier for an attribute, followed by a set of tuples that each contain a partition key (e.g., date key) and a corresponding value of the attribute for the given partition key. Newer values of the attribute may then be appended to the end of the element in the merged record. Consequently, the merged record may contain a full history of attribute-value pairs for the entity represented by the entity key.

Third, generation of merged record 220 from records 212-214 may be triggered by a number of events. For example, analysis apparatus 204 may generate a new merged record 220 and/or update existing merged records in data repository 234 on a periodic basis and/or whenever new records 212-214 are available from inputs 202. Alternatively, the analysis apparatus may generate merged records from inputs 202 in a “lazy” fashion, in which new records 212-214 from inputs 202 are merged only when a query is received by management apparatus 208.

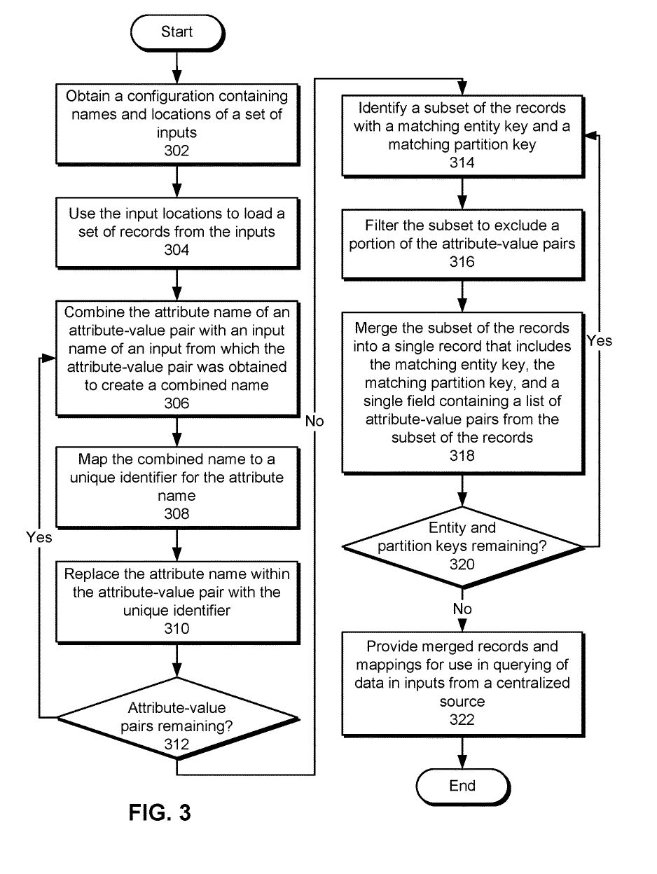

FIG. 3 shows a flowchart illustrating the processing of data in accordance with the disclosed embodiments. More specifically, FIG. 3 shows a flowchart of efficiently consolidating data from multiple inputs. In one or more embodiments, one or more of the steps may be omitted, repeated, and/or performed in a different order. Accordingly, the specific arrangement of steps shown in FIG. 3 should not be construed as limiting the scope of the embodiments.

Initially, a configuration containing names and locations of a set of inputs is obtained (operation 302). For example, the names and paths of the inputs in a distributed filesystem may be specified in a configuration file. Each input may include a set of records, and each record may include an entity key, a partition key, and one or more attribute-value pairs.

The input locations are used to load the records from the inputs (operation 304). For example, the path to each input may be obtained from the configuration and used to retrieve a set of records from the input. Such retrieval may be performed periodically, when a request for updated data from the inputs is received, and/or when an update to the records in the input is detected.

Next, an attribute name of an attribute-value pair may be combined with an input name of an input from which the attribute-value pair was obtained to create a combined name (operation 306) that represents a unique, namespaced attribute name for the attribute. The combined name is also mapped to a unique identifier for the attribute name (operation 308), and the attribute name within the attribute-value pair is replaced with the unique identifier (operation 310). For example, the attribute name may be mapped to a numeric (e.g., integer) identifier, and the mapping may be stored in a file, table, list, and/or other type of structure for subsequent retrieval and use. The identifier may then be used in lieu of the longer attribute name in the attribute-value pair to reduce the amount of space required to store the attribute-value pair. If a mapping of the attribute name to the identifier already exists in the structure, the mapping may be retrieved from the structure, and the identifier in the mapping may be substituted for the attribute name in the attribute-value pair to reduce the storage requirements associated with the attribute-value pair. Operations 306-310 may be repeated for remaining attribute-value pairs (operation 312) in the records from the inputs.

A subset of the records with a matching entity key and a matching partition key is then identified (operation 314) and filtered to exclude a portion of the attribute-value pairs (operation 316). For example, all records with the same entity key and partition key may be identified, and attribute-value pairs with non-meaningful values such as null values, zero numeric values, and/or default values may be removed and/or omitted from the records. The records may also be filtered to exclude data from one or more inputs and/or specific attribute-value pairs in the records.

The filtered subset of records is then merged into a single record that includes the matching entity key, matching partition key, and a single field containing a list of attribute-value pairs from the subset (operation 318). For example, the single record may include the entity key, partition key, and a list of tuples, with each tuple containing an identifier for an attribute name followed by a value for the corresponding attribute. The single record may be stored in a flattened (e.g., binary or text) format instead of a conventional table-based format (e.g., in a relational database) to further reduce the amount of space required to store the attribute-value pairs. Operations 314-318 may be repeated for all unique combinations of entity and partition keys (operation 320) in the set of records.

Finally, the merged records and mappings may be provided for use in querying of data in the inputs from a centralized source (operation 322). For example, the merged records and mappings may be used to process Structured Query Language (SQL)-like queries of the data; return results that match the queries to a GUI, CLI, and/or other type of user interface; and/or generate summary statistics or visualizations associated with the attribute-value pairs.

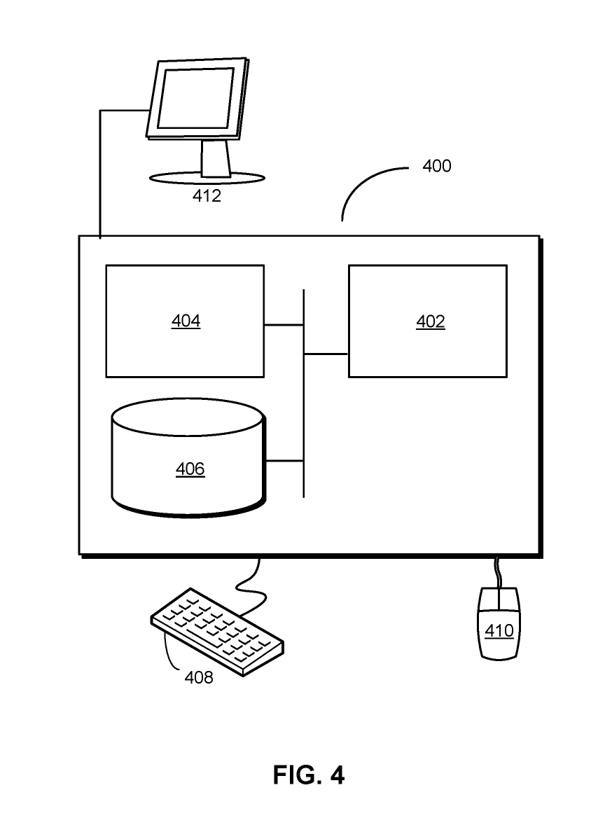

FIG. 4 shows a computer system 400. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In particular, computer system 400 may provide a system for processing data. The system may include an analysis apparatus that loads a set of records from a set of inputs, with each record containing an entity key, a partition key, and one or more attribute-value pairs. For each attribute-value pair in the set of records, the analysis apparatus may map an attribute name in the attribute-value pair to a unique identifier for the attribute name and replace the attribute name in the attribute-value pair with the unique identifier. The analysis apparatus may further identify a subset of the records with a matching entity key and a matching partition key and merge the subset of the records into a single record that include the matching entity key, the matching partition key, and a single field comprising a list of attribute-value pairs from the subset of the records. The system may additionally include a management apparatus that provides the single record and the mapping for use in querying of data in the set of inputs from a centralized source.

In addition, one or more components of computer system 400 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that consolidates metrics, dimensions, and/or other attribute-value pairs from records in a set of inputs for use in querying and subsequent processing by a set of remote users and/or electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of records from a set of inputs, wherein each of the records comprises an entity key, a partition key, and one or more attribute-value pairs;
for each attribute-value pair in the set of records:
mapping an attribute name in the attribute-value pair to a unique identifier for the attribute name; and
replacing, by one or more computer systems, the attribute name within the attribute-value pair with the unique identifier;
identifying, by the one or more computer systems, a subset of the records with a matching entity key and a matching partition key;
merging, by the one or more computer systems, the subset of the records into a single record that comprises the matching entity key, the matching partition key, and a single field comprising a list of attribute-value pairs from the subset of the records; and
providing the single record and the mapping for use in querying of data in the set of inputs from a centralized source.

2. The method of claim 1, wherein mapping the attribute name in the attribute-value pair to the unique identifier for the attribute name comprises:
combining the attribute name with an input name of an input from which the attribute-value pair was obtained to create a combined name; and
assigning the unique identifier to the combined name.

3. The method of claim 1, further comprising:
filtering the subset of the records to exclude, from the single record, a portion of attribute-value pairs in the subset.

4. The method of claim 3, wherein filtering the subset of the records to exclude, from the single record, the portion of attribute-value pairs in the subset comprises:
omitting an attribute-value pair from the single record when a value in the attribute-value pair matches a non-meaningful value.

5. The method of claim 4, wherein the non-meaningful value comprises at least one of:
a null value;
a zero numeric value; and
a default value.

6. The method of claim 1, wherein obtaining the set of records from the set of inputs comprises:
obtaining a configuration comprising a set of input names of the inputs and a set of input locations of the inputs; and
using the input locations to load the records from the inputs.

7. The method of claim 1, wherein mapping the attribute name to the unique identifier for the attribute name comprises at least one of:
adding the mapping to a list of mappings of attribute names to unique identifiers; and
identifying an existing mapping of the attribute name to the unique identifier within the list of mappings.

8. The method of claim 1, wherein providing the single record for use in querying of data in the set of inputs from the centralized source comprises:
providing the single record in a flattened format.

9. The method of claim 1, wherein the entity key represents a member of an online professional network.

10. The method of claim 1, wherein the partition key comprises a date key.

11. The method of claim 1, wherein an attribute-value pair in the one or more attribute-value pairs comprises an attribute that is a metric and a value that is a measurement of the metric.

12. An apparatus, comprising:
one or more processors; and
memory storing instructions that, when executed by the one or more processors, cause the apparatus to:
obtain a set of records from a set of inputs, wherein each of the records comprises an entity key, a partition key, and one or more attribute-value pairs;
for each attribute-value pair in the set of records:
map an attribute name in the attribute-value pair to a unique identifier for the attribute name; and
replace the attribute name within the attribute-value pair with the unique identifier;
identify a subset of the records with a matching entity key and a matching partition key;
merge the subset of the records into a single record that comprises the matching entity key, the matching partition key, and a single field comprising a list of attribute-value pairs from the subset of the records; and
provide the single record and the mapping for use in querying of data in the set of inputs from a centralized source.

13. The apparatus of claim 12, wherein mapping the attribute name in the attribute-value pair to the unique identifier for the attribute name comprises:
combining the attribute name with an input name of an input from which the attribute-value pair was obtained to create a combined name; and
assigning the unique identifier to the combined name..

14. The apparatus of claim 12, wherein the memory further stores instructions that, when executed by the one or more processors, cause the apparatus to:
filter the subset of the records to exclude, from the single record, a portion of attribute-value pairs in the subset.

15. The apparatus of claim 14, wherein filtering the subset of the records to exclude, from the single record, the portion of attribute-value pairs in the subset comprises:
omitting an attribute-value pair from the single record when a value in the attribute-value pair matches a non-meaningful value.

16. The apparatus of claim 15, wherein the non-meaningful value comprises at least one of:
a null value;
a zero numeric value; and
a default value.

17. The apparatus of claim 12, wherein obtaining the set of records from the set of inputs comprises:
obtaining a configuration comprising a set of input names of the inputs and a set of input locations of the inputs; and
using the input locations to load the records from the inputs.

18. The apparatus of claim 12, wherein mapping the attribute name to the unique identifier for the attribute name comprises at least one of:
adding the mapping to a list of mappings of attribute names to unique identifiers; and
identifying an existing mapping of the attribute name to the unique identifier within the list of mappings.

19. A system, comprising:
an analysis module comprising a non-transitory computer-readable medium comprising instructions that, when executed by one or more processors, cause the system to:
obtain a set of records from a set of inputs, wherein each of the records comprises an entity key, a partition key, and one or more attribute-value pairs;
for each attribute-value pair in the set of records:
map an attribute name in the attribute-value pair to a unique identifier for the attribute name; and
replace the attribute name within the attribute-value pair with the unique identifier;
identify a subset of the records with a matching entity key and a matching partition key;
merge the subset of the records into a single record that comprises the matching entity key, the matching partition key, and a single field comprising a list of attribute-value pairs from the subset of the records; and
a management module comprising a non-transitory computer-readable medium comprising instructions that, when executed by the one or more processors, cause the system to provide the single record and the mapping for use in querying of data in the set of inputs from a centralized source.

20. The system of claim 19, wherein merging the subset of the records into the single record comprises:
omitting an attribute-value pair from the single record when a value in the attribute-value pair matches a non-meaningful value.
